(19) United States
(12) Patent Application Publication
(10) Pub. No.: US 2005/0279674 A1
(43) Pub. Date: Dec. 22, 2005

(54) Method of preparing a postman's walk with both letters and large-format atricles

(75) Inventor: Francois Gillet, Lyon (FR)

Correspondence Address: SUGHRUE MION, PLLC, 2100 PENNSYLVANIA AVENUE, N.W., SUITE 800, WASHINGTON, DC, 20037, US

(73) Assignee: SOLYSTIC, Gentilly (FR)

(21) Appl. No.: 10/529,785

(22) PCT Filed: Dec. 30, 2004
(86) PCT No.: PCT/FR04/50763

§ 371 Date: Mar. 30, 2005

(30) Foreign Application Priority Data
Feb. 18, 2004 (FR) 04/50291

(51) Int. Cl. B07C 5/00; G06K 9/00

(52) U.S. Cl. 209/584

(57) ABSTRACT

For preparing a postman's walk in a plurality of sorting passes with mail items including both letters (1) and large-format flat items or “flats” (4), the method consists in:
subjecting the letters to a first sorting pass in a first sorting machine (2) and subjecting the flats to a first sorting pass in a second sorting machine (5), with “letters” sorting outlets (3) and “flats” sorting outlets (6) that correspond to one another; grouping together the mail items coming from corresponding sorting outlets; and
performing a second sorting pass manually using a set (21) of trays (8), with various delivery points on the postman's walk being assigned to each tray.

The invention relates to a method of preparing a postman's walk in a plurality of sorting passes with mail items including both letters and large-format flat items that are commonly referred to as “flats” in the literature of the field of the invention.

Preparing a postman's walk consists in grouping together the mail items (letters and flats) by successive delivery points in the order of the walk, in a plurality of sorting passes.

The mail items can be handled manually and/or by using “sequencing” machines that usually work in one or more passes (generally 2 or 3 passes).

“Sequencing” machines that handle both letters and flats exist but they are not very cost-effective because of their low rates of throughput.

It is known that postmen on their walks usually carry a single bag from which they deliver both letters and flats. In order to prepare such a postman's walk, it is possible to proceed as follows. Firstly a postman's walk is prepared with the letters. Then another walk is prepared with the flats. Then, afterwards, the two walks are merged manually into one. The preparation of the final, single postman's walk thus currently requires many handling operations (a plurality of passes in sorting machines, and manual handling) which increase the cost associated with the delivery, and such preparation currently represents two-thirds of the total cost of handling a mail item.

An object of the invention is to propose another method of preparing a postman's walk in a plurality of passes with mail items including both letters and flats.

Another object of the invention is to propose a method that is reliable, fast and that requires few handling operations.

A novel approach to delivering mail, known as Delivery Point Packaging or “DPP”, consists in bagging or bundling all of the mail items addressed to the same delivery point on the postman's walk.

Another object of the invention is also to propose such a method of preparing a postman's walk in a plurality of passes that is compatible with DPP-type delivery.

To this end, the invention provides a method of preparing a postman's walk in a plurality of sorting passes with mail items including both letters and large-format flat items or “flats”, said method being characterized in that it consists in the following steps:

subjecting the letters to a first sorting pass in a first sorting machine having a certain number of first sorting outlets and configured for a certain sorting plan;

subjecting the flats to a first sorting pass in a second sorting machine including second sorting outlets that correspond to respective ones of the first sorting outlets, the second sorting machine being configured for the same sorting plan as the first sorting machine, and the sorting plan for the sorting machines being designed so that a set of delivery points of the postman's walk are assigned respectively to each first sorting outlet and to each second sorting outlet;

grouping together the mail items coming from each corresponding first and second sorting outlet to form as many groups of mail items as there are first or second sorting outlets; and

subjecting the groups of mail items to a second sorting pass using a set of trays as follows:
a) for a group of mail items, assigning to the trays respective ones of the delivery points from the set of delivery points assigned to the sorting outlets from which the mail items of the group of mail items come; and
b) distributing the mail items from the group of mail items into the various trays as a function of the delivery points assigned to the trays, and repeating steps a) and b) for each other group of mail items.

The method of the invention may advantageously offer the following features:

the sorting machines are configured with a sorting plan whereby respective ones of consecutive delivery points on the postman's walk are assigned to the various successive sorting outlets;

the sorting machines are configured with a sorting plan whereby a plurality of consecutive delivery points on the postman's walk are assigned to each sorting outlet;

in order to distribute a group of mail items into the trays, each tray is caused to display information representing the delivery point assigned to the tray;

during distribution of the mail items into the trays, the mail items are bagged; and

the operation of bagging the mail items consists in bagging all of the mail items coming from the same tray in the same bag.

The invention also provides apparatus for implementing the method as defined above, said apparatus comprising a first sorting machine for sorting letters, a second sorting machine for sorting flats, and a set of trays, each of which is equipped with information display device for displaying information representing a delivery point on a postman's walk.

In another embodiment of the invention, the apparatus further comprises a bagging device for bagging mail items.

The method and apparatus of the invention for preparing a postman's walk are described below with reference to the accompanying drawings, in which:

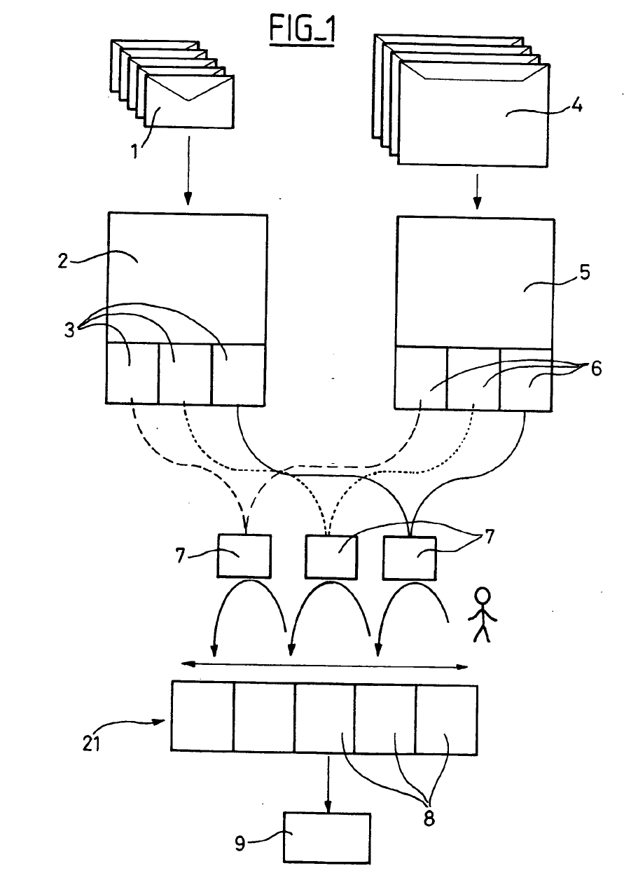

FIG. 1 very diagrammatically shows the method of the invention for preparing a postman's walk;

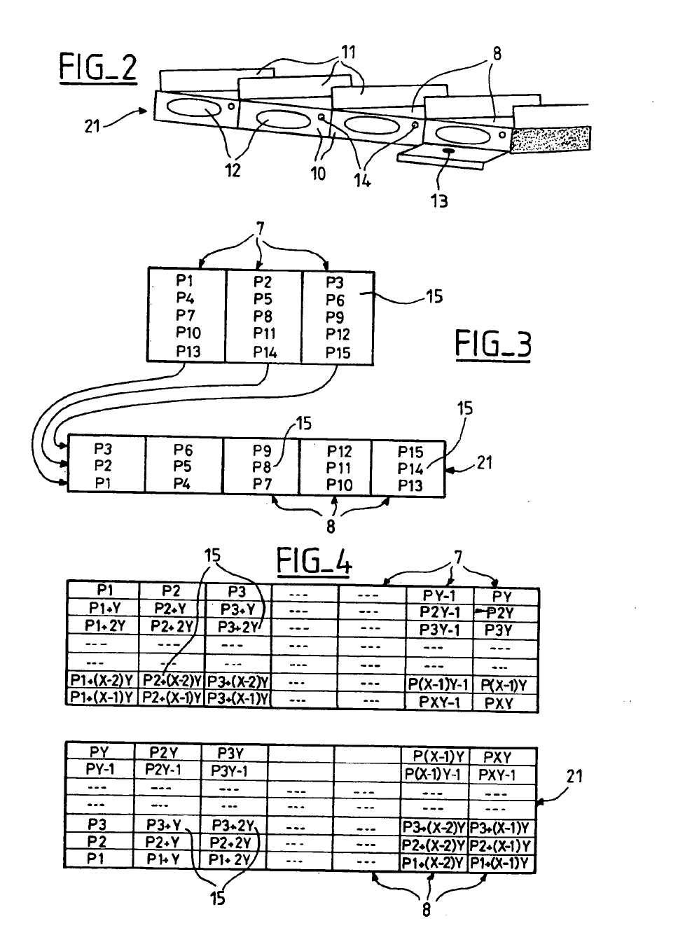

FIG. 2 very diagrammatically shows a set of manual sorting trays for implementing a method of the invention;

FIG. 3 shows a first example of an implementation of a method of the invention;

FIG. 4 more generally shows an implementation of the method of the invention shown in FIG. 3;

FIG. 5 very diagrammatically shows a bagging device for implementing a method of the invention;

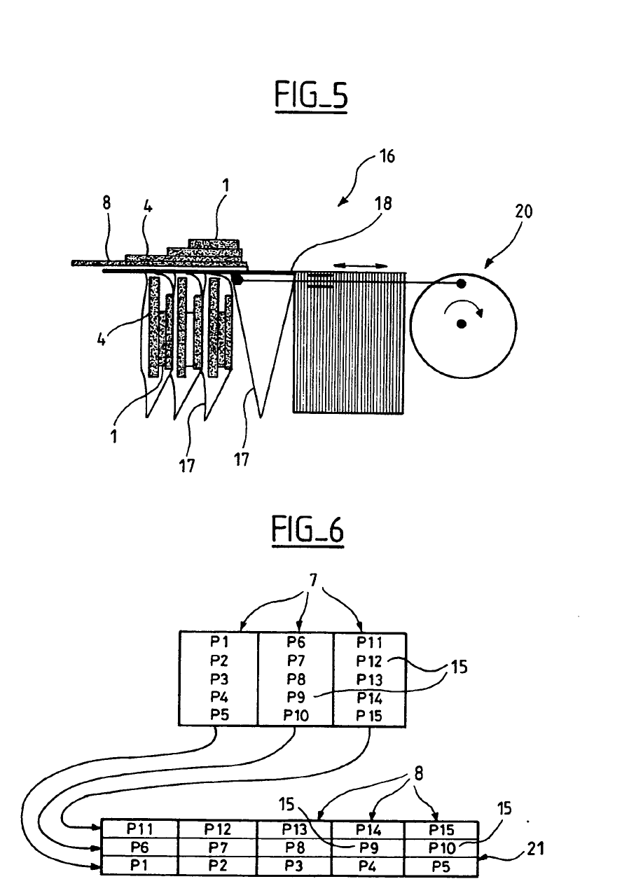

FIG. 6 shows another example of an implementation of a method of the invention;

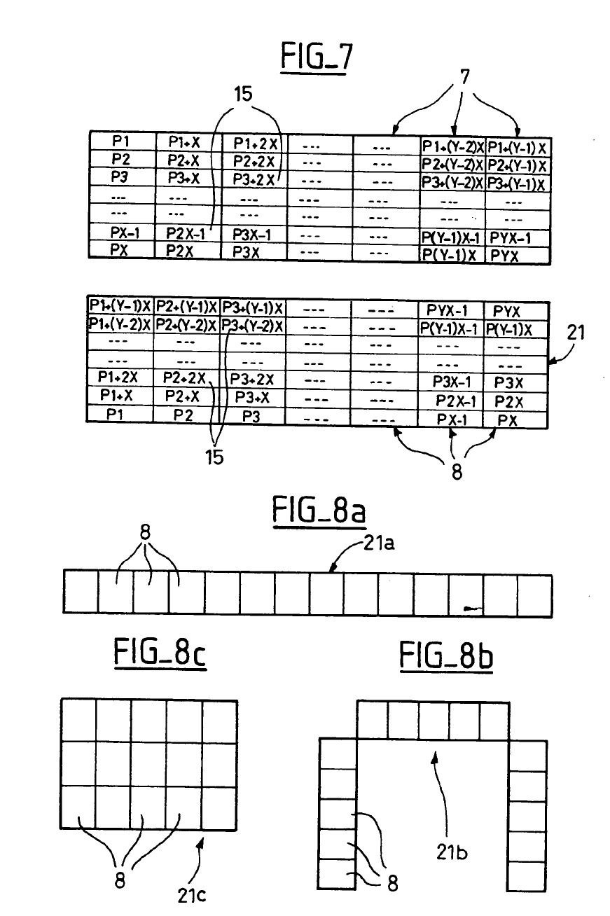

FIG. 7 more generally shows an implementation of a method of the invention shown in FIG. 6; and

FIGS. 8a, 8b, and 8c very diagrammatically show possible arrangements for the sorting trays serving to implement a method of the invention.

FIG. 1 very diagrammatically shows the various steps of a method of the invention for preparing a postman's walk. The postman's walk is made up of a certain number of delivery points (typically in the range 600 delivery points to 800 delivery points). Letters 1 for the postman's walk are put through a first sorting machine 2 designed to sequence them into “letters” sorting outlets 3 during a first sorting pass. Similarly flats 4 for the postman's walk are put through another sorting machine 5 designed to sequence them into “flats” sorting outlets 6 during a first sorting pass.

Each of the sorting outlets 3, 6 are assigned a certain number of delivery points on the walk in a predetermined manner, two examples of which are described below with reference to FIGS. 3, 4, 6, and 7. It should be understood that the sorting outlets 3 (or 6) have different delivery points.

The sorting machines 2, 5 for the letters and the flats are configured so as to have identical sorting plans, i.e. each of the “letters” first sorting outlets 3 to which a certain number of delivery points are assigned corresponds to a respective “flats” second sorting outlet 6 having the same delivery points.

An operator groups together manually the letters and the flats coming from a “letters” first outlet 3 and from its corresponding “flats” sorting outlet in order to form a group 7 of mail items including both letters and flats.

The operator does the same with the other corresponding sorting outlets 3 and 6 so as to form as many groups 7 of mail items as there are sorting outlets 3 or 6 per sorting machine.

As the mail items are grouped together or at the end of the grouping operation, a manual second sorting pass is performed by means of a set 21 of trays 8. For this purpose, an operator takes a group 7 of mail items and assigns to respective ones of the trays 8 the delivery points that have been assigned to the sorting outlets 3, 6 from which the mail items of the group come. Then, the operator manually distributes the mail items 1, 4 of the group 7 into the various trays 8 as a function of the delivery points assigned to the trays 8. The operator proceeds in the same way as indicated above for the other groups 7 of mail items. It is preferable for the groups 7 of mail items to be handled in an order that corresponds to the order of the sorting outlets 3 and 6.

While the mail items are being distributed into the trays, the mail items are bagged or bundled 9.

In order to make it easier to understand the method, FIG. 1 shows sorting machines 2, 5 each having only three sorting outlets 3, 6, but the method can be used with a larger number of sorting outlets (typically in the range one sorting outlet to several tens of sorting outlets). Similarly, the method can be implemented with more than five trays 8.

With reference to FIG. 1, which shows sorting machines 2, 5 each having three sorting outlets 3, 6, and a set 21 of five trays 8, it is possible to prepare a postman's walk having fifteen delivery points.

FIG. 2 shows trays 8, each of which is formed by a base 10 and by two parallel side walls 11. The adjacent trays 8 are separated by a side wall 11. Each tray 8 can be equipped with an alphanumeric display 12 on which information representing the point of delivery that is assigned to the tray, e.g. the number representing the point of delivery on the postman's walk, can be displayed at any time. The information on the display 12 relates to the configuration of the sorting plans of the machines 2, 4, and can, for example, come from the sorting machines. More particularly, the operator takes a group of mail items. The operator causes the display 12 of each tray 8 to display the information representing the delivery point assigned to the tray 8 for that group 7 of mail items, e.g. by pressing a button 13 which serves to change the information displayed on all of the displays 12. The operator does the same for all of the groups 7 of mail items.

The operator can be assisted in identifying the tray in which a mail item should be deposited, such assistance being given by a device, e.g. an optical reader device for scanning a bar code printed on the mail item or a voice recognition device recognizing the address on the mail item, making it possible to identify the delivery point of the mail item and thus the tray serving to receive it. For example, the tray can be identified by means of an indicator light arranged on the tray or by lighting the display 12 of the tray 8.

A visual alarm signal can also be sent to the operator by means of an indicator light 14 placed in the base 10 of each tray 8, the indicator light of a tray lighting up in the event that the mail items of the delivery point assigned to said tray require special handling, e.g. when users of a delivery point have requested that their mail be forwarded to some other delivery address.

FIG. 3 shows a first algorithm of the invention for sequencing mail items in the particular case of a postman's walk including fifteen delivery points 15, in this example, numbered in the order of the walk from P1 to P15.

After the first sorting pass has been performed in the two machines 2, 5, the mail items contained in the sorting outlets 3, 6 are grouped together in groups 7. In each group 7, FIG. 3 shows the set of delivery points that are assigned to the corresponding sorting outlets 3 and 6 forming the group 7 of mail items.

The mail items for five delivery points 15 are distributed in each of the three groups 7 as a function of their delivery points 15, and the order of arrival of the mail items in their respective group 7 is random, i.e. it does not depend on their delivery points 15. In this first sequencing algorithm for sequencing the mail items, it can be seen that the delivery points P1 to P15 are distributed in three groups so that consecutive delivery points on the postman's walk are situated in two successive groups 7. Thus, consecutive delivery points on the postman's walk are situated in the first group 7 and in the last group 7. Thus, as shown in FIG. 3, the first, second, and third groups 7 receive the mail items 1, 4 addressed to respective ones of the delivery points P1, P2, and P3, and to respective ones of P4, P5, and P6, and so on to P15.

Taking the groups 7 of mail items, a second sorting pass is performed using a set 21 of trays 8. The number of trays 8 of the set 21 of trays is equal to the number of delivery points 15 per group 7 of mail items (five, in this example). In the example, the first group of mail items receiving the delivery points 15 P1, P4, P7, P10, P13 are taken, said delivery points 15 are assigned to respective ones of the trays 8, i.e. the delivery points P1, P4, P7, P10, and P13 are assigned respectively to the first, second, third, fourth, and fifth trays, and the mail items 1, 4 of said first group 7 of mail items are distributed to the trays 8 as a function of the delivery points 15 assigned to the trays 8. Delivery points are then assigned likewise for the second and third groups 7 of mail items. Thus, the first tray 8 is thus assigned successively to the delivery points P1, P2, and P3, the second tray 8 is assigned successively to the delivery points P4, P5, and P6, and so on for all of the trays 8.

Therefore:

each tray 8 contains mail items ordered by delivery points 15;

delivery points assigned successively to a tray are consecutive delivery points on the postman's walk; and

the last delivery point assigned to a tray is consecutive to the first delivery point assigned to the next tray.

FIG. 4 shows 7 groups 7 of mail items formed at the end of the first sorting pass and X trays 8. The relationship X*Y=P applies, where P corresponds to the number of delivery points 15 on the walk. FIG. 5 shows an extension of the sorting principle of FIG. 3, with the indices X and Y.

In Europe, for example, a postman's walk includes approximately 600 delivery points 15. Such a walk can thus be prepared in accordance with the invention in two sorting passes on the basis of twenty, fifteen, or twelve sorting outlets (groups of mail items), and of respectively thirty, forty, or fifty trays. The best “sorting outlet number Y”—“tray number X” combination can vary as a function of availability in terms of sorting machines, of space, of operators, and of time, and its object is to optimize the speed of preparation of the postman's walk by managing the proportion of manual sorting compared with machine sorting.

In the method of the invention and in the first sequencing algorithm shown in FIGS. 3 and 4, at the end of the second sorting pass, the letters 1 and the flats 4 are sorted into the trays 8 by consecutive delivery points 15 on the postman's walk, and, if the contents of the trays 8 are superposed, without mixing them, in the order of said trays 8, i.e. the contents of the first tray, then the contents of the second tray, then the contents of third tray, and so on, the letters 1 and the flats 4 are grouped together by delivery points 15 in the order of the postman's walk.

In order to facilitate handling the mail items 1, 4, the contents of each tray 8 can be deposited in a bag or can be bundled at the end of distribution of all of the mail items, so that the postman takes as many bags or bundles as there are trays 8, and so that said bags or bundles contain the mail items 1, 4 for a number of consecutive delivery points equal to the number of sorting outlets 3, 6 used. Bundling can be performed in the manner described in Patent Application FR 2 841 901. For this purpose, the trays can be formed on a belt provided with battens that can advance so as to bring the contents of the trays to an automatic bagging machine.

In addition, the mail items 1, 4 can be bagged by delivery point for DPP-type delivery. In order to perform this particular type of bagging, a bagging device 16 shown in FIG. 5 is arranged on each tray 8, each tray 8 being mounted to pivot so that it can be tilted downwards to empty its contents under gravity into a plastic bag 17 disposed open below. The bagging device 16 is made up of two parallel support rods 18 disposed under the tray 8 in the same plane as the tray 8, of a batch 19 of plastic bags threaded over the support rods 18 at the handles of the bags, and of a system 20 for moving the bags. For example, the system 20 for moving the plastic bags 17 is a connecting rod and crank handle system as shown in FIG. 5.

The device is arranged so as to hold a plastic bag 17 open under a tray 8 so as to receive the mail items from the tray, so as to push the full plastic bags 17 along the support rods 18, and so as to open a new plastic bag 17 under the tray 8. Therefore, when all of the mail items 1, 4 for a given delivery point are in a tray 8, i.e. when a group of mail items 7 has been distributed over the set 21 of trays 8, the trays 8 are tilted and emptied into the open plastic bags 17 below. Each of the full plastic bags 17 contains all of the mail items 1, 4 for a delivery point, they are pushed along the support rods 18, and they are accumulated in succession in the order of delivery points 15 inherent to the trays 8. This operation is repeated after each group 7 of mail items has been distributed. The bags accumulated under each tray 8 are then gathered together in the order of the bags 17 and in the order of the trays 8 once all of the mail items 1, 4 have been sorted. The postman's walk is thus prepared, with one bag 17 being proposed per delivery point, the bags being in the same order as the delivery points on the postman's walk.

FIG. 6 shows a second algorithm of the invention for sequencing the mail items in the particular case of a postman's walk including fifteen delivery points 15 numbered in the order of the postman's walk from P1 to P15, and prepared in three sorting outlets 3 and 6 and five trays 8.

After the first sorting pass has been performed in the two machines 2, 5, the mail items contained in the sorting outlets 3, 6 are grouped together in groups 7 of mail items. In each group, FIG. 6 shows the set of delivery points 15 assigned to the corresponding sorting outlets 3 and 6 forming the group 7 of mail items.

The mail items for five delivery points 15 are distributed into each of the three groups 7 as a function of their delivery points. In this second algorithm for sequencing the mail items, it can be seen that the delivery points P1 to P15 are distributed into the three groups so that a plurality of consecutive delivery points 15 on the postman's walk are distributed into each group 7. Thus, two successive groups 7 of mail items include respective ones of two consecutive delivery points on the postman's walk. Thus, as shown in FIG. 6, the first, second, and third groups 7 receive respectively the mail items addressed to the delivery points P1, P2, P3, P4, and P5, to the delivery points P6, P7, P8, P9, and P10, and to the delivery points P11, P12, P13, P14, and P15.

Taking the groups 7 of mail items, a second sorting pass is performed by means of a set 21 of trays 8. The number of trays 8 of the set of trays is equal to the number of delivery points 15 per group 7 of mail items, i.e. five in this example. In the example, the first group 7 of mail items that receives the delivery points 15 P1, P2, P3, P4, and P5 is taken, said delivery points 15 are assigned to respective ones of the trays 8, i.e. the delivery points 15 P1, P2, P3, P4, and P5 are assigned respectively to the first, second, third, fourth, and fifth trays 8, and the mail items of said first group 7 of mail items are distributed into the trays 8 as a function of the delivery points 15 assigned to the trays 8. The same is then done for the second and third groups of mail items. The first tray is thus assigned successively to the delivery points P1, P6, and P11, the second tray is assigned successively to the delivery points P2, P7, and P12, and so on for all of the trays.

FIG. 7 shows Y groups 7 of mail items formed at the end of the first sorting pass and X trays 8. The relationship X*Y=P applies, where P corresponds to the number of delivery points 15 on the walk. FIG. 7 shows an extension of the sorting principle of FIG. 3, with the indices X and Y.

With the second sequencing algorithm, the mail items 1, 4 of two successive trays are addressed to consecutive delivery points 15 on the postman's walk when the mail items of a group 7 of mail items are distributed. By bundling the contents of the trays 8 in the order of the trays 8 at the end of distribution of each group 6 of mail items, the mail items 1, 4 are bundled by delivery point 15, with the delivery points of the bundle in the order of the postman's walk.

This bundling can be performed in the manner described in Patent FR 2 841 801. For this purpose, the trays can be formed on a belt provided with battens that can advance so as to bring the contents of the trays to an automatic bundling machine.

The method of the invention makes it possible to achieve a considerable saving in time (about 20%) relative to current methods because the preparation in the sorting machine (first pass) requires only a single pass and a small number of sorting outlets. Thus, the same machine can simultaneously prepare numerous postman's walks, and requires fewer emptying operations for emptying the sorting outlets, such operations limiting the throughput of the sorting machine. Such a saving in time at the sorting machine is doubled since both letters and flats are handled. The required merging of the flats and of the letters is facilitated by the trays, which also make it possible automatically to bundle or to bag the mail items by delivery point.

The method of the invention also makes it possible to spread the machine sorting out over time. It is possible to perform the first sorting passes for non-urgent mail items during off-peak hours, to keep said non-urgent mail items in a small space, and to group together in ordered manner the non-urgent mail items with the other mail items before the manual second sorting pass.

FIGS. 8a, 8b, and 8c are plan views of various layouts for a set of trays 21a, 21b, 21c. The trays can be disposed in a single row 21a but that is impractical because said row is then very long, and the operator must then move to a considerable extent in order to distribute the mail items into the trays 8. For example, a single row of forty trays that are 30 centimeters in width has a length of twelve meters. Therefore it is preferable for the set of trays to be disposed in a U-shaped layout 21b or in three parallel, superposed, and offset rows 21c of trays 8.

Naturally, the invention is in no way limited to the above-described embodiments, but rather it extends to cover any variant that is readily apparent to the person skilled in the art, in particular as regards the shape and the arrangement of the trays, or indeed the grouping together and the ordered handling of the mail items.

1. A method of preparing a postman's walk in a plurality of sorting passes with mail items including both letters (1) and large-format flat items or “flats” (4), said method being characterized in that it comprises the following steps:
subjecting the letters to a first sorting pass in a first sorting machine (2) having a certain number of first sorting outlets (3) and configured for a certain sorting plan;
subjecting the flats to a first sorting pass in a second sorting machine (5) including second sorting outlets (6) that correspond to respective ones of the first sorting outlets, the second sorting machine being configured for the same sorting plan as the first sorting machine, and the sorting plan for the sorting machines being designed so that a set of delivery points (15) of the postman's walk are assigned to each first sorting outlet or to each second sorting outlet respectively;
grouping together the mail items coming from each corresponding first and second sorting outlet to form as many groups (7) of mail items as there are first or second sorting outlets; and
subjecting the groups of mail items to a second sorting pass using a set (21) of trays (8) as follows:
a) for a group of mail items, assigning to the trays respective ones of the delivery points from the set of delivery points assigned to the sorting outlets from which the mail items of the group of mail items come; and
b) distributing the mail items from the group of mail items into the various trays as a function of the delivery points assigned to the trays, and repeating steps a) and b) for each other group of mail items.

2. A method according to claim 1, in which the sorting machines are configured with a sorting plan whereby respective ones of consecutive delivery points on the postman's walk are assigned to the various successive sorting outlets.

3. A method according to claim 1, in which the sorting machines are configured with a sorting plan whereby a plurality of consecutive delivery points on the postman's walk are assigned to each sorting outlet.

4. A method according to claim 1, in which, in order to distribute a group of mail items into the trays, each tray is caused to display information representing the delivery point assigned to the tray.

5. A method according to claim 1, in which, during distribution of the mail items into the trays, the mail items are bagged.

6. A method according to claim 5, in which the operation of bagging the mail items comprises bagging all of the mail items coming from the same tray in the same bag (7).

7. Apparatus for implementing the method according to claim 1, said apparatus comprising a first sorting machine (2) for sorting letters, a second sorting machine (5) for sorting flats, and a set of trays (8), each of which is equipped with information display device (12) for displaying information representing a delivery point on a postman's walk.

8. Apparatus according to claim 7, further comprising a bagging device for bagging mail items (16).
